(19) United States
(12) Patent Application Publication
(10) Pub. No.: US 2007/0008836 A1
(43) Pub. Date: Jan. 11, 2007

(54) Optical disk device

(76) Inventors: Seiji Imagawa, Yokohama (JP); Motoyuki Suzuki, Yokohama (JP); Akio Fukushima, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/362,169

(22) Filed: Feb. 27, 2006

(30) Foreign Application Priority Data
Jun. 22, 2005 (JP) 2005-181403

(51) Int. Cl. G11B 7/00

(52) U.S. Cl. 369/44.23

(57) ABSTRACT

An optical disk drive having a laser source for irradiating an optical beam onto an optical disk, a lens unit to focus the optical beam from the laser source onto the optical disk, a drive unit for driving the lens unit, and a high-frequency signal output unit for producing a high-frequency signal. The drive unit drives the lens unit by applying the high-frequency signal before the optical disk is started to reproduce, and drives it without applying the high-frequency signal after the optical disk is started to reproduce. Thus, it is possible to effectively control the aberration correction mechanism using a linear actuator.

### INCORPORATION BY REFERENCE

The present application claims priority from Japanese application JP2005-181403 filed on Jun. 22, 2005, the content of which is hereby incorporated by reference into this application.

### BACKGROUND OF THE INVENTION

The present invention relates to an optical disk drive that reproduces optical disks

Until now, a technique is proposed of a closed loop control using a movable lens and a position sensor for the way the aberrations in the optical disk drive are corrected as disclosed in, for example, JP-A-2002-352449.

In addition, another technique for the aberration correction method has been offered in which the closed loop control is made by computing the amount of correction from the movable lens and reproduced signals with long and short periods as described in, for example, JP-A-2004-241102.

### SUMMARY OF THE INVENTION

As described in the above patent documents, an approach is employed to drive the aberration-correction movable lens in the optical-axis direction by using a linear actuator as one of the spherical aberration correction methods.

However, the aberration-correcting movable lens is required to have an ability to firmly hold its position once fixed in the optical-axis direction, or retainability without being affected by the external vibration or the like.

In addition, the movable lens has a problem that it is apt to faintly move in the direction perpendicular to the optical axis or to have a tilt to the optical axis due to the looseness between the movable portion and the drive shaft.

Thus, it is an objective of the invention to provide an optical disk drive capable of solving the above problems and of highly reliable operation.

According to the invention, in order to solve the above problems, there is provided an optical disk drive having a laser source for irradiating an optical beam onto an optical disk, a lens unit to focus the optical beam from the laser source onto the optical disk, a drive unit to drive the lens unit, and a high-frequency signal output unit for producing a high-frequency signal. Before the optical disk is started to reproduce, the drive unit impresses the high-frequency signal to drive the lens unit. After the optical disk is started to reproduce, it does not impress the high-frequency signal but drives the lens unit without that signal.

According to this invention, it is possible to provide a highly reliable optical disk drive.

### BRIEF DESCRIPTION OF THE DRAWINGS

FIG. 1 is a block diagram to which reference is made in explaining the elements of the construction of embodiments according to the invention.

FIG. 2 is a block diagram to which reference is made in explaining the elements of the construction of the aberration correction control signal generator of embodiment 1.

FIG. 3 is a block diagram to which reference is made in explaining the elements of the construction of the aberration correction control signal generator of embodiment 2.

FIG. 4 is an explanatory diagram 1 for the adjustment of the operating point and sensitivity of the position signal generator.

FIG. 5 is an explanatory diagram 2 for the adjustment of the operating point and sensitivity of the position signal generator.

FIGS. 6A and 6B are graphs to which reference is made in explaining the operation of the target range judging unit.

FIG. 7 is graphs to which reference is made in explaining the operation for the addition of the dither signal.

FIG. 8 is graphs to which reference is made in explaining the operation for the addition of the dither signal at the time of the start and stop of the dither signal.

FIG. 9 is an explanatory diagram 1 for the operation of the gain control unit.

FIG. 10 shows a table 1 for the setting of gains.

FIG. 11 is an explanatory diagram 2 for the operation of the gain control unit.

FIG. 12 shows a table 2 for the setting of gains.

FIG. 13 is a flowchart for driving the aberration correcting element with the tracking control off.

FIG. 14 is a flowchart for driving the aberration correcting element with the tracking control on.

### DETAILED DESCRIPTION OF THE INVENTION

Embodiments of the invention will be described in detail.

### Embodiment 1

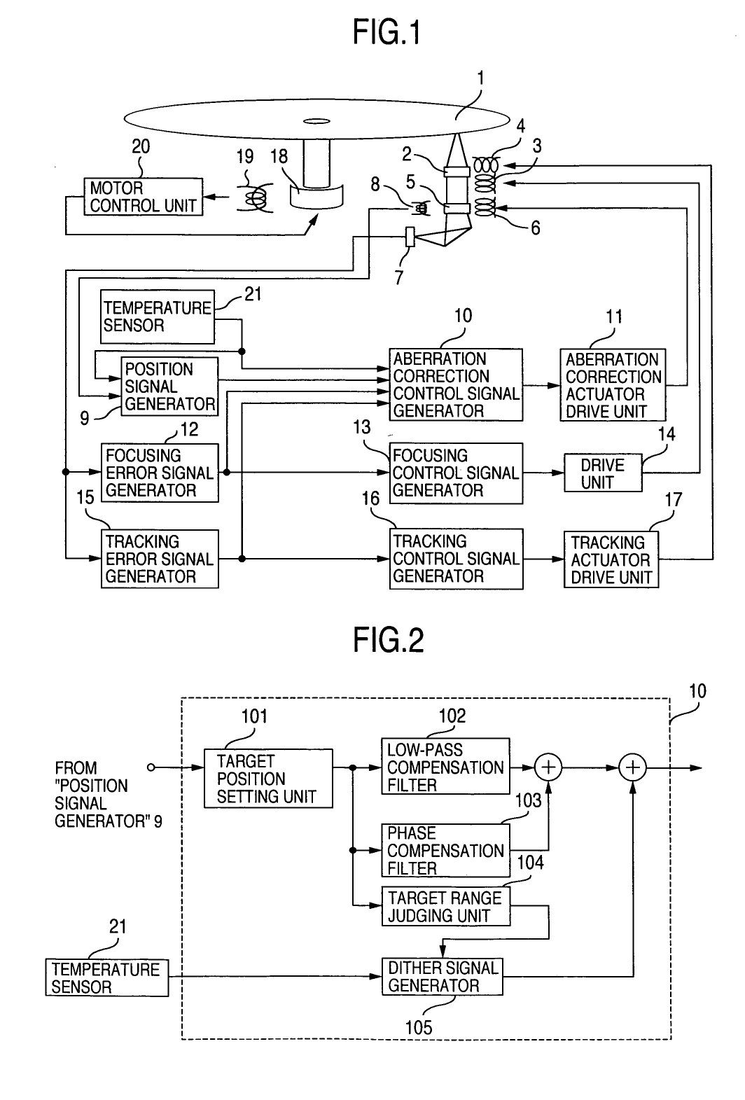

The construction of an optical disk drive of the invention will be described first with reference to FIGS. 1 and 2.

Referring to FIG. 1, there are shown a disk 1 for recording/reproducing data, an objective lens 2 for use in gathering beam flux on the disk 1, a focusing actuator 3 to drive the objective lens 2 in the rotation-axis direction of the disk 1, a tracking actuator 4 to drive the objective lens 2 in the radius direction of the disk 2, an aberration correcting lens 5 for correcting the aberrations and an aberration correcting actuator 6 to drive the aberration correcting lens 5 in the optical-axis direction. In addition, there are shown an optical detector 7 for optically detecting the disk 1, a position detector 8 for detecting the position of the aberration correcting lens, a position signal generator 9 for setting the operating point and sensitivity relative to the output from the position detector 8, and an aberration correction control signal generator 10 to control the aberration correcting actuator 6 so that the aberration correcting lens 5 can be set in a predetermined position. Moreover, there are shown an aberration-correcting actuator drive unit 11 for driving the aberration correcting actuator, a focusing error signal generator 12 for generating a signal of the focusing-direction error of the objective lens relative to the disk, a focusing-control signal generator 13 to control the focusing actuator so that the beam spot can be located just on the recording surface or reproducing surface of the disk, a focusing-actuator drive unit 14 for driving the focusing actuator, and a tracking-error signal generator 15 for generating a signal of the tracking error of the objective lens relative to the track of the disk. Also, there are shown a tracking-control signal generator 16 to control the tracking actuator so that the beam spot can be located just on a predetermined track of the disk, a tracking-actuator drive unit 17 for driving the tracking actuator, a spindle motor 18 for rotating the disk, a frequency generator 19 for generating a signal proportional to the rotation speed of the spindle motor, a motor control unit 20 to control the spindle motor to rotate with a predetermined speed, and a temperature sensor 21.

In addition, FIG. 2 is a block diagram of the aberration correction control signal generator 10. In FIG. 2, there are shown a target position setting unit 101 for setting the target position of the aberration correcting lens, a low-pass compensation filter 102, a phase compensation filter 103, a target range judging unit 104 for judging whether the error between the aberration correcting lens position and the target position is within a predetermined range, and a dither signal generator 105.

The outline of the operation of each block and the relation between the blocks will be described next.

Referring to FIG. 1, the focusing actuator 3 moves the objective lens 2 in the rotation axis direction of the disk, and the tracking actuator 4 moves the objective lens 2 in the radius direction of the disk. The optical detector 7 converts the reflected light into an electric signal, and supplies the electric signal to the focusing-error signal generator 12 and tracking-error signal generator 15. The focusing-error signal generator 12 generates a focusing error signal based on the fed signal, and supplies it to the focusing-control signal generator 13 and aberration-correction control signal generator 10. The focusing-control signal generator 13 generates a focusing control signal based on the fed signal, and supplies it to the focusing-actuator drive unit 14. The focusing-actuator drive unit 14 drives the focusing actuator 3 in accordance with the fed signal. The tracking-error signal generator 15 generates a tracking error signal based on the fed signal, and supplies it to the tracking-control signal generator 16 and aberration-correction control signal generator 10. The tracking-control signal generator 16 generates a tracking control signal based on the fed signal, and supplies it to the tracking-actuator drive unit 17. The tracking-actuator drive unit 17 drives the tracking actuator 4 in response to the fed signal. In addition, the aberration correcting actuator 6 moves the aberration-correcting lens 5 in the optical-axis direction. The aberration-correcting lens position detector 8 converts the aberration correcting lens position into an electric signal, and supplies it to the position signal generator 9.

The position signal generator 9 corrects its operating point and sensitivity relative to the fed signal, and supplies the corrected signal to the aberration-correction control signal generator 10. In the aberration correction control signal generator 10, the target-position setting unit 101 compares the fed signal with a target value, and supplies the resulting signal to the low-pass compensation filter 102, phase compensation filter 103 and target range judging unit 104. The temperature sensor 21 converts the drive-inside temperature into an electric signal, and supplies it to the dither signal generator 105. The target-range judging unit 104 uses the fed signal from the target-position setting unit 101 to judge whether the aberration-correcting lens is out of a predetermined range with respect to the target position, and supplies the judgment signal to the dither signal generator 105. The dither signal generator 105 determines the frequency and amplitude of a dither signal based on the signal fed from the temperature sensor 21, and turns the generation of this dither signal on or off in accordance with the signal fed from the target range judging unit 104. The aberration correction control signal generator 10 produces a sum signal of the output signals produced from the low-pass compensation filter 102, phase compensation filter 103 and dither signal generator 105, and supplies it to the aberration-correcting actuator drive unit 11. The aberration-correcting actuator drive unit 11 drives the aberration correcting actuator 6 in response to the fed signal. The spindle motor 18 drives the disk 1 to rotate. The frequency generator 19 converts the rotation speed information of the spindle motor 18 into an electric signal, and supplies it to the motor control unit 20. The motor control unit 20 controls the spindle motor 18 for rotating the disk 1 to rotate with a predetermine speed based on the fed signal.

The main blocks will be described in detail.

The adjustment of the operating point and sensitivity of the position signal generator 9 to the input signal will be first described with reference to FIG. 4. Here, the adjustment of the operating point and sensitivity means that the offset and gain of the signal to the aberration correction control signal generator 10 that makes digital processing are adjusted before the supply of this signal to the generator 10 so that the maximum resolution can be surely obtained within the practical movement range of the aberration correcting lens. In other words, the operating point is adjusted by the offset control, and the sensitivity is adjusted by the gain control. Thus, this adjustment enables the aberration to be corrected with high precision.

The aberration-correcting lens is required to move within a wide range and to control with high precision, and thus it needs a high resolution. In order for both wide dynamic range and high resolution to be achieved when the control system partially makes digital processing, it is considered to employ a method for increasing the bit number or bit-precision of the AD converter. However, since the specification of DSP (digital signal processor) is necessary to change, it is not easy to achieve. Therefore, first the operating point and sensitivity are adjusted according to the method shown in FIG. 4.

As illustrated in FIG. 4, the movable range of the aberration correcting lens has a practical range and an unused range. The practical range is the region lying between the target positions of the aberration-correcting lens relative to the layers of the two-layer recording/reproducing disk. The unused range is the region corresponding to the distance by which the aberration-correcting lens can be additionally moved considering the optical pickup assembly tolerance, but it is not used in the actual operation. Although the location of the practical range in its movable range depends upon each optical disk drive, it suffices to detect the position signal within the practical range if it can be detected after the target position of the aberration-correcting lens is determined relative to the 0-layer or 1-layer of the disk on each drive. (FIG. 4 shows the case in which the practical range lies substantially at the center of the movable range.)

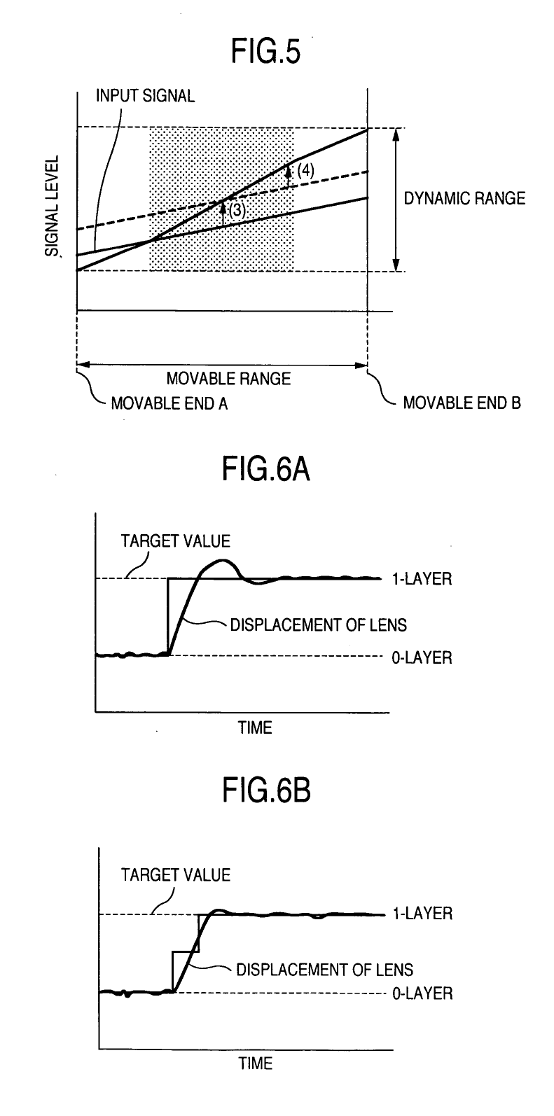

Accordingly, the operating point of the position signal generator 9 can be adjusted to lie at the center of the signal level by applying an offset to the input signal as indicated by (1). In addition, the practical range can be adjusted to enter in the whole dynamic range of DSP by controlling the gain as indicated by (2), thus assuring the resolution. When the target position of the aberration correcting lens is determined relative to the 0-layer or 1-layer, adjustment is performed so that the position signal within the movable range can be detected as shown in FIG. 5. In other words, the position signal generator 9 determines the target position under the conditions that an offset is applied to the input signal as indicated by (3) and that the gain is set as indicated by (4).

Description will be made of the operation of the target position setting unit 101 at the focusing jump time when the beam spot moves between the layers of the two-layer disk. When the beam spot moves between the layers, it is necessary to also change the target position of the aberration-correcting lens. When the aberration-correcting lens moves slower than the focusing control in which the objective lens is moved in the focusing direction, the target position of the aberration-correcting lens is required to previously change to the destination layer. However, when the aberration-correcting lens is moved from the original-layer target position, the amplitudes of the focusing and tracking error signals are reduced, thus making the focusing and tracking control unstable. When the target position is abruptly changed in a single step as shown in FIG. 6A, the operation of the aberration-correcting lens gives rise to an overshoot, incurring further instability. Thus, the target-position setting unit 101 changes from the original position to the destination target position in steps as shown in FIG. 6B to reduce the overshoot. Alternatively, the low-pass compensation filter 102 and phase compensation filter 103 may be changed in their characteristics to achieve the same effect. In addition, the tracking control in which the error signal amplitude could be remarkably reduced may be disabled before the aberration-correcting lens switches the target positions.

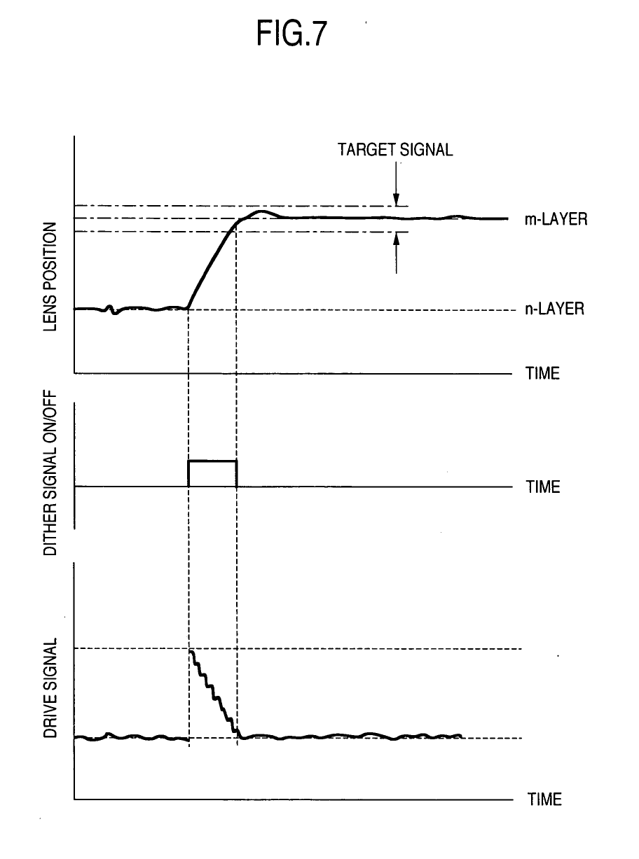

The operation of the target-range judging unit 104 will be described in detail with reference to FIG. 7.

The aberration-correcting lens position target range of the target-range judging unit 104 is set according to the suppression specification of the deviation and variation necessary for each layer as shown in FIG. 7. FIG. 7 is graphs schematically showing the lens position for the movement of the beam spot between the layers, the on/off of the dither signal (high-frequency signal), and the aberration-correction control signal. Before the change of the target position, the target-range judging unit 104 turns on the output of the dither signal generator 105. Then, the target-position setting unit 101 sets the target on the destination layer.

The purpose of the application of the dither signal to the drive signal for driving the spherical aberration correcting element is to enable it to be smoothly driven. In other words, the linear actuator for use in driving the beam expander for correcting the spherical aberration enables the optical pickup to be small-sized as compared to the current stepping motor, and it has a merit of lower cost than the piezoactuator. However, the friction to the drive shaft increases for the necessity of looseness reduction and high retainability. Therefore, if the object to be driven is tried to control without application of dither signal, it suddenly moves, thus accurate control being difficult. In this case, if the dither signal is applied to the drive signal for the spherical aberration correcting element, or for the linear actuator, the actuator is continuously controlled to perate finely as indicated at the bottom graph in FIG. 7, thus less affected by the static friction so that it can be smoothly driven.

The target range judging unit 104 maintains the dither signal generator 105 to operate until the output of the target position setting unit 101 enters in the target range. After the output of the target position setting unit 101 moves into the target range, the judging unit 104 controls the dither signal generator 105 to be made in the off-state. When the position of the actuator is being changed through the stepwise ranges toward the target range as described above, the dither signal generator 105 is kept in operation to output fine signals or to be ceased even if the output of the target position setting unit 101 comes into each of the stepwise ranges.

In other words, the dither signal is applied only when the linear actuator is being driven. The dither signal is not impressed when it is not driven, or during the recording or reproduction. If the dither signal were always applied, the spherical aberration correcting element would continue to finely vibrate even after the arrival at the target position, thus adversely affecting the focusing control.

The phrase “linear actuator is being driven” given above means that, when the target position is controlled to change, the high-frequency signal is continuously applied to the element to adjust its position until the element arrives in the target range.

In addition, the driving of the linear actuator as described above is performed before the reproduction processing of the read-out signal from the optical disk, or before the demodulation of the read-out signal from the optical disk and production of video signal or audio signal.

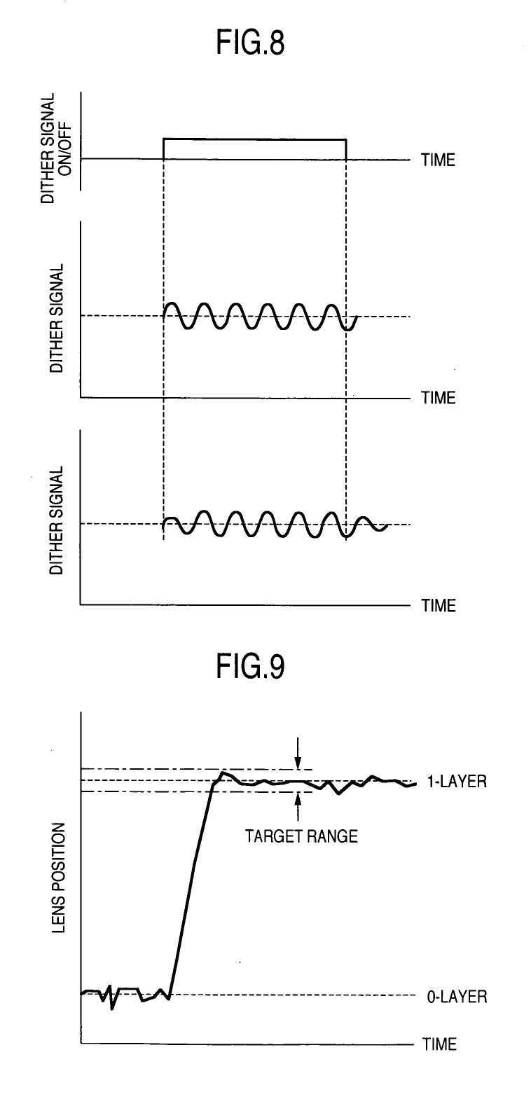

Moreover, the dither signal generator 105 generates such a signal as to start changing with a zero-amplitude phase and to stop at another zero-amplitude phase as shown in FIG. 8. Alternatively, it generates such a signal as to gradually increase the amplitude when starting to produce the signal and to gradually decrease the amplitude when stopping from producing the signal.

The reason why the dither signal is started to apply at the zero-amplitude phase or stopped from applying at the zero-amplitude phase is that the sudden application or stop of the dither signal might adversely affect the control even if the dither signal is a very small oscillation as compared with the drive signal. In this connection, the start or stop of application of the dither signal at the zero-amplitude phase will result in smooth control, thus better results being acquired. The gradual increase or decrease of the amplitude of the dither signal at the start or stop of application will also result in smooth control.

Description will be made of a method for determining the frequency and amplitude of the signal produced from the dither signal generator 105. The signal from the dither signal generator 105 needs a predetermined frequency or below and a predetermined amplitude or above in order that the movable portion of the aberration correcting mechanism including the aberration correcting lens can be operated without influence of the static friction to the stationary part. In addition, in order to suppress the effect of the movement of the aberration correcting lens on the focusing control and tracking control, the frequency and amplitude of the signal must be increased above and decreased below predetermined values, respectively. The influence on the focusing control and tracking control is determined according to the amplitude variation of the focusing error signal and tracking error signal before the application of the dither signal. Alternatively, it is determined on the basis of the performance fluctuation of the reproduction of the data recorded on the disk. Thus, the dither signal generator 105 determines the amplitude and frequency for each temperature that meet these conditions, and generates the most appropriate dither signal based on the output from the temperature sensor 21. In other words, the amplitude of the signal must be set so high as to reduce the effect of the static friction and so low as not to adversely affect the focusing control and tracking control. Similarly, the frequency needs to be determined so high as not to adversely affect the focusing control and tracking control and so low as to reduce the effect of the static friction.

Here, the frequency will be specifically mentioned. The frequency f of the dither signal takes the following range. In other words, if the main resonance of the aberration correction driving actuator is represented by f0_s, the control bandwidth of the aberration correction driving actuator by fc_s, the control band of the focusing actuator by fc_f, and the control band of the tracking actuator by fc_t, then the following expressions can be obtained.
f0_s<f<fc_s (1)
or when fc_s<fc_f, fc_t,
   fc_s<f<fc_f or fc_t (any smaller one) (2)
   fc_f or fc_t (any larger one)<f (3)
or when fc_f, fc_t<fc_s,
   fc_f or fc_t (any larger one)<f<fc_s (4)
   In the present circumstances, the condition of fc_s=0.5 kHz<fc_f, fc_t=5˜10 kHz is estimated.

### Embodiment 2

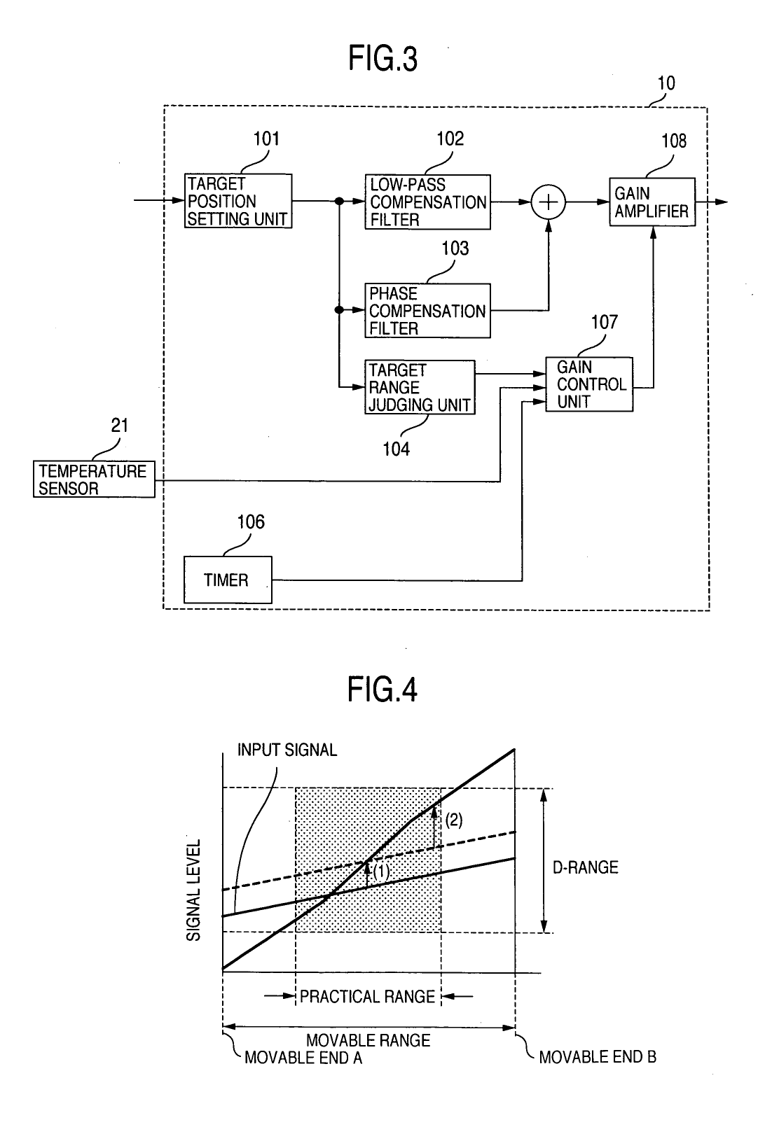

The construction of the optical disk drive of the invention will be described with reference to FIGS. 1 and 3.

In the embodiment 2, the blocks 1 through 21 shown in FIG. 1 are the same as in embodiment 1, and thus will not be described. FIG. 3 is a block diagram of the aberration correction control signal generator 10 of the embodiment 2. The blocks 101 through 104 shown in FIG. 3 are the same as in embodiment 1, and thus will not be described. In FIG. 3, there are shown a timer 106, a gain control unit 107 for the aberration correction control, and a gain amplifier 108 of the aberration correction control loop.

The outline of the operation of each block and the relation between the blocks will be described.

The focusing control, tracking control and spindle control are the same as in embodiment 1, and thus will not be described. The aberration correcting actuator 6 moves the aberration correcting lens 5 in the optical-axis direction. The aberration-correcting lens position detector 8 converts the position of the aberration correcting lens into an electric signal, and supplies it to the position signal generator 9. The position signal generator 9 corrects the operating point and sensitivity given for the fed signal, and supplies the corrected signal to the aberration correction control signal generator 10. In the aberration correction control signal generator 10, the target position setting unit 101 compares the fed signal and the target value, and supplies the compared result to the low-pass compensation filter 102, phase compensation filter 103 and target range judging unit 104. The temperature sensor 21 converts the drive-inside temperature into an electric signal, and supplies it to the gain control unit 107. The timer 106 supplies time information to the gain control unit 107. The target range judging unit 104 judges whether the aberration correcting lens is located out of a predetermined range of the target position on the basis of the fed signal, and supplies the judgment result signal to the gain control unit 107. The gain control unit 107 determines a set value of gain on the basis of the signals from the temperature sensor 21 and target range judging unit 104, and sets the gain of the gain amplifier 108 according to the set value. The aberration correction control signal generator 10 supplies the sum signal of the low-pass compensation filter 102 and phase compensation filter 103 to the aberration correcting actuator drive unit 11 through the gain amplifier 108. The aberration correcting actuator drive unit 11 drives the aberration correcting actuator 6 according to the fed signal.

The operation of the main blocks will be described in detail.

The adjustment of the operating point and sensitivity of the position signal generator 9 is the same as in embodiment 1. The operation of the target position setting unit 101 at the time of focusing jump is the same as in embodiment 1.

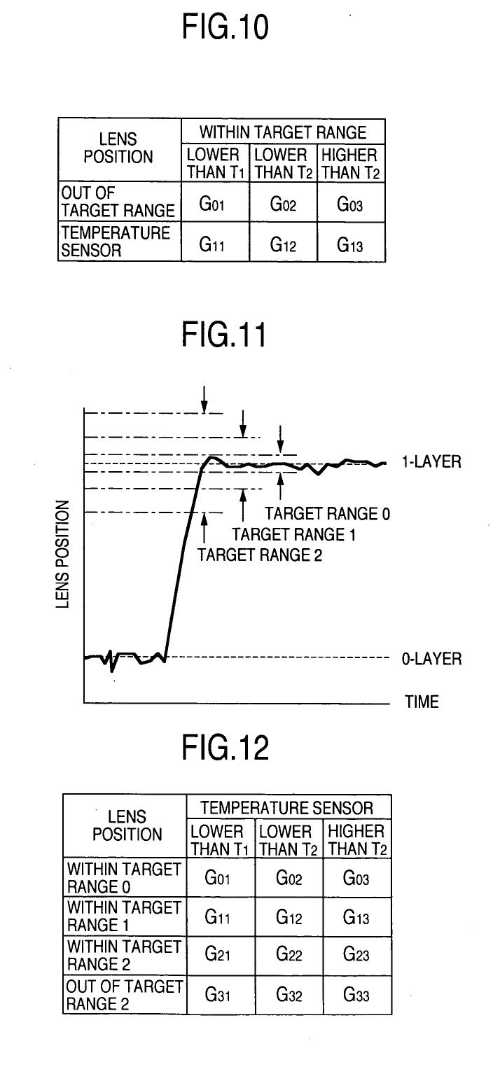

The operation of the target range judging unit 104 and gain control unit 107 will be described in detail with reference to FIGS. 9 and 10. The target range of the target range judging unit 104 about the position of the aberration correcting lens is set according to the deviation and variation suppression specification necessary for each layer as shown in FIG. 9. The target range judging unit 104 judges whether the signal fed from the target position setting unit 101 is within the target range, and supplies the judgment result signal to the gain control unit 107. The gain control unit 107 judges the signal fed from the temperature sensor 21 by using thresholds T1 and T2 (T1<T2), and sets G01, G02, G03, G11, G12 and G13 in the gain amplifier 108 according to the judgment result signal fed from the target range judging unit 104. The gains have the relations of G01<G11, G02<G12, G03<G13. In addition, when the static friction between the movable portion and fixed portion of the aberration correcting mechanism decreases with the increase of temperature, the relations of gains are G01<G02<G03, and G11<G12<G13. When the static friction increases with the increase of temperature, the relations of gains are G01>G02>G03, G11>G12>G13.

Here, the target range judging unit 104 may have one or more target ranges except the target range based on the suppression specification as shown in FIG. 11. In this case, the gains G21, G22, G23, G31, G32 and G33 are added on the table of FIG. 10 as established gains. The gain control unit 107 has the table shown in FIG. 11. In this case, the gains respectively take the lowest values in the target range 0 that means that the lens has arrived at the target position, and take higher values in the other ranges as the lens approaches to the target range, that is, G01<G31<G21<G11, G02<G32<G22<G12, G03<G33<G23<G13.

In addition, the gain control unit 107 increases the gains to be set in the gain amplifier 108 to exceed the values shown in the above table according to the time information fed from the timer 106 when the signal fed from the target position setting unit 101 does not come into each target range in a predetermined time.

### Embodiment 3

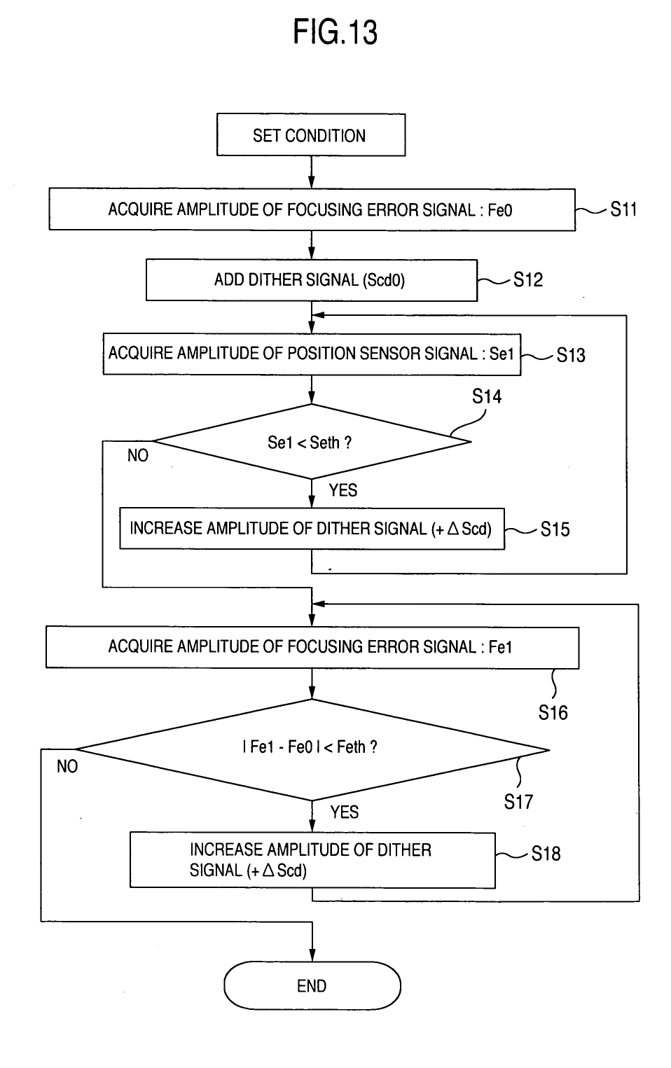

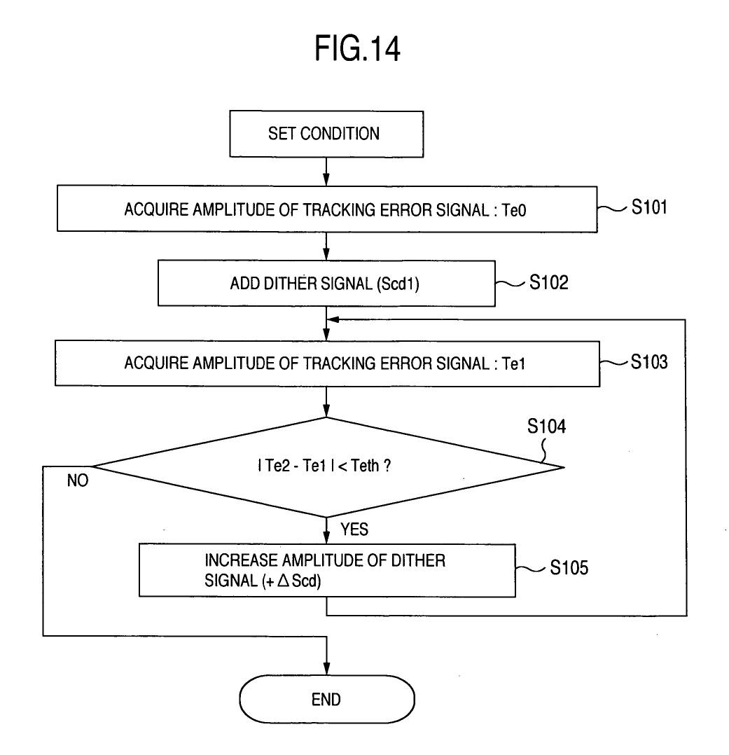

The flowchart of a specific control in embodiment 1 will be described with reference to FIGS. 13 and 14.

First, referring to FIG. 13, when the aberration correcting element needs to be driven with the focusing control on and with the tracking control off, condition setting is first performed in order to suppress the effect of the superposition of high-frequency signal and the drive signal for the aberration correcting element on the focusing control. At this time, the condition setting is made so that the focusing error signal can be observed when the focusing control and tracking control are both turned off. In addition, the high-frequency signal is not applied.

Then, the focusing error signal amplitude is acquired under the condition that the high-frequency signal is not applied (S11). This value is represented by Fe0.

Next, the dither signal (high-frequency signal) is added to the drive signal for the aberration correcting element (S12). At this time, the initial amplitude (Scd0) of the high-frequency signal is assumed to be small enough such as zero.

Then, the output amplitude of the position sensor is measured, and the amplitude of the high-frequency signal is increased ΔScd by ΔScd (S15) until the measured amplitude (Se1) becomes larger than a predetermined value (Seth) (S14). The amplitude of the high-frequency signal satisfying the condition of Se1>Seth is represented by Scd1.

Then, the amplitude of the focusing error signal is measured (S16), and the amplitude of the high-frequency signal is increased ΔScd by ΔScd (S18) until the absolute value of the difference between the measured amplitude (Fe1) and the previously given amplitude Fe0 becomes larger than a predetermined value (Feth) (S17). The amplitude of the high-frequency signal satisfying the condition of |Fe1−Fe0|>Feth is represented by Scd2.

The actually used high-frequency signal amplitude Scd is set to satisfy the condition of Scd1<Scd<Scd2 by using the obtained values Scd1 and Scd2. For example, the amplitude Scd may take an intermediate value between Scd1 and Scd2, or as Scd=(Scd1+Scd2)/2.

Referring to FIG. 14, when the aberration correcting element needs to be driven with the focusing control on and the tracking control on, it is necessary to suppress the effect of the superposition of the high-frequency signal and the drive signal for the aberration correcting element on the focusing control and tracking control. In this case, the processing shown in FIG. 14 is necessary in addition to that shown in FIG. 13.

The condition setting in the flowchart of FIG. 14 is performed so that the tracking error signal can be observed with the focusing control on and tracking control off. In addition, the high-frequency signal is not applied.

Then, the tracking error signal amplitude is acquired with the high-frequency signal not applied (S101). This value is represented by Te0.

Next, the high-frequency signal is added to the drive signal for the aberration correcting element (S102). At this time, the initial amplitude (Scd1) of the high-frequency signal is assumed to be the value detected in the flowchart shown in FIG. 13.

Then, the tracking error signal amplitude is measured (S103), and the amplitude of the high-frequency signal is increased ΔScd by ΔScd (S105) until the absolute value of the difference between the measured amplitude (Te1) and the above given Te0 becomes larger than a predetermined value (Teth) (S104). The amplitude of the high-frequency signal satisfying the condition of |Te1−Te0|>Teth is represented by Scd3.

The actual used high-frequency signal amplitude Scd is set to satisfy the condition of Scd1<Scd<Scd2 or Scd3 (any smaller one) by using the above Scd1, Scd2 and Scd3. For example, the amplitude may take an intermediate value between Scd1 and Scd2 or Scd3, or as Scd=(Scd1+Scd2 or Scd3)/2 in order to assure the margin to the environmental change such as temperature change.

As described above, according to the above embodiments, when the aberration correcting lens is moved, the dither signal is superimposed on the control signal or the gain of the control loop is increased, thereby enabling the aberration correcting lens to be controlled with high precision. Therefore, the linear actuator can be used with less lens tilt and less looseness in the aberration correcting mechanism, and thus a small-sized and inexpensive optical disk drive can be provided.

It should be further understood by those skilled in the art that although the foregoing description has been made on embodiments of the invention, the invention is not limited thereto and various changes and modifications may be made without departing from the spirit of the invention and the scope of the appended claims.

1. An optical disk drive for reproducing an optical disk, comprising:
a laser source for irradiating an optical beam onto said optical disk;
a lens unit for focusing said optical beam from said laser source onto said optical disk;
a spherical aberration correcting unit for correcting the spherical aberrations of said lens unit;
a drive unit for driving said lens unit; and
a high-frequency signal output unit for generating a high-frequency signal, whereby said drive unit adjusts the position of said spherical aberration correcting unit in response to a drive signal with said high-frequency signal impressed thereto, said high-frequency signal is stopped from being impressed after said adjustment of the position, and then the signal read from said optical disk is started to be processed for its reproduction.

2. An optical disk drive according to claim 1, wherein said drive unit impresses said high-frequency signal to said drive signal and adjusts the position of said spherical aberration correcting unit when said spherical aberration correcting unit changes its control target position, and stops said high-frequency signal from being impressed when said spherical aberration correcting unit arrives in a control target range.

3. An optical disk drive according to claim 1, wherein said processing for the reproduction is to demodulate the signal read from said optical disk to thereby produce a video or audio signal.

4. An optical disk drive having an optical pickup, said optical disk drive comprising:
a spherical aberration correcting unit for correcting spherical aberrations;
a position detector for detecting the position of said spherical aberration correcting unit;
a drive unit for driving said spherical aberration correcting unit; and
a control unit for controlling said drive unit, wherein said control unit controls the position of said spherical aberration correcting unit through said drive unit in response to the output from said position detector.

5. An optical disk drive according to claim 4, further comprising a high-frequency signal output unit for producing a high-frequency signal, wherein said control unit controls said high-frequency signal output unit to apply said high-frequency signal to a drive signal for said drive unit when said spherical aberration correcting unit changes its control target position, and controls said high-frequency signal output unit to be turned off not to produce said high-frequency signal when said spherical aberration correcting unit is found to have arrived in a control target range from the output from said position detector.

6. An optical disk drive according to claim 5, further comprising a temperature detector for detecting temperature, wherein said high-frequency signal output unit changes the amplitude or frequency of said high-frequency signal according to the output from said temperature detector.

7. An optical disk drive according to claim 5, wherein said control unit controls said high-frequency signal produced from said high-frequency signal output unit to be gradually increased in its amplitude and at the same time to be applied to said drive signal for driving said drive unit.

8. An optical disk drive according to claim 5, wherein said control unit controls said high-frequency signal produced from said high-frequency signal output unit to be started to apply to said drive signal for driving said drive unit from when said high-frequency signal has a phase where the amplitude of said high-frequency signal substantially becomes zero.

9. An optical disk drive according to claim 4, wherein said control unit controls the gain of a feedback control loop to be increased when the output from said position detector does not converge to within a predetermined range in a constant time.

10. An optical disk drive according to claim 4, wherein said control unit controls the gain of a feedback control loop for controlling said spherical aberration correcting unit to be changed in response to the output from said position detector.

11. An optical disk drive according to claim 9, wherein the possible output from said position detector is previously divided into a plurality of ranges a(1), a(2), . . . , a(N) (a(1)>a(2)>. . . >a(N)), and said control unit controls the gain of said feedback control loop to be increased as G(1), G(2), . . . , G(N) (G(1)<G(2)<. . . <G(N)) as the output of said position detector approaches to a control target as a(1), . . . , a(N)(a(1)>a(2)>. . . >a(N), respectively, and then to be set to G(0) (G(1)≧G(0)) when the output from said position detector has entered into a tolerance range a(0).

12. An optical disk drive according to claim 4, wherein the following elements are further provided in order to increase the resolution of said position detector for the practical range of the movable range of said spherical aberration correcting unit:
an operating point correcting unit for correcting the operating point of said spherical aberration correcting unit; and
a correcting unit for correcting the gain of a drive signal for driving said drive unit.

13. An optical disk drive comprising:
a laser source for irradiating a optical beam onto an optical disk on which the data to be reproduced is previously recorded;
a lens unit to focus said optical beam from said laser source onto said optical disk;
a spherical aberration correcting unit for correcting the spherical aberrations of said lens unit that are caused depending on the characteristics of said disk;
a drive unit for driving said lens unit in the focusing direction; and
a high-frequency signal output unit for producing a high-frequency signal, whereby said drive unit controls said spherical aberration correcting unit to be adjusted in its position by using a drive signal with said high-frequency signal superimposed thereon, and then controls said high-frequency signal to be stopped from being applied after the completion of said position adjustment.

14. An optical disk drive according to claim 10, wherein the possible output from said position detector is previously divided into a plurality of ranges a(1), a(2), . . . , a(N) (a(1)>a(2)>. . . >a(N)), and said control unit controls the gain of said feedback control loop to be increased as G(1), G(2), . . . , G(N) (G(1)<G(2)<. . . <G(N)) as the output of said position detector approaches to a control target as a(1), . . . , a(N) (a(1)>a(2)>. . . >a(N), respectively, and then to be set to G(0) (G(1)≧G(0)) when the output from said position detector has entered into a tolerance range a(0).
